(19) United States
(12) Patent Application Publication
(10) Pub. No.: US 2008/0263183 A1
(43) Pub. Date: Oct. 23, 2008

(54) Management of Kernel configurations for nodes in a clustered system

(76) Inventors: Lisa Midori Nishiyama, Sunnyvale, CA (US); C.P. Vijay Kumar, Cupertino, CA (US); Steven Roth, Sunnyvale, CA (US); Harshavardhan R. Kuntur, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/788,436

(22) Filed: Apr. 20, 2007

(51) Int. Cl. G06F 15/177

(52) U.S. Cl. 709/220

(57) ABSTRACT

Various approaches for managing kernel configuration files in a cluster computing arrangement are disclosed. In one approach, a first set of kernel configuration files are installed networked storage, and a first node is booted using the first set of kernel configuration files. A copy of the first set of kernel configuration files is stored in networked storage as a default kernel configuration in response to an administrator initiated first operation. In response to an administrator-initiated second operation a copy of the default kernel configuration is stored as a second set of kernel configuration files for a second node of the cluster. The second node is booted with the second set of kernel configuration files.

### FIELD OF THE INVENTION

The present disclosure generally relates to managing the kernel configurations for the nodes in a clustered computing arrangement.

### BACKGROUND

One central component of a computer system operating in a UNIX® environment is an operating system kernel. In a typical UNIX® system, many applications, or processes may be running. All these processes use a memory-resident kernel to provide system services. The kernel manages the set of processes that are running on the system by ensuring that each such process is provided with some central processor unit (CPU) cycles when needed and by arranging for each such process to be resident in memory so that the process can run when required. The kernel provides a standard set of services that allows the processes to interact with the kernel and to simplify the task of the application writer. In the UNIX® environment, these services are sometimes referred to as “system calls” because the process calls a routine in the kernel (system) to undertake some specific task. Code in the kernel will then perform the task for the process, and will return a result to the process. In essence, the kernel fills in the gaps between what the process intends to happen, and how the system hardware needs to be controlled to achieve the process's objective.

The kernel's standard set of services is expressed as kernel modules (or simply, modules). The kernel typically includes modules such as drivers, including Streams drivers and device drivers, file system modules, scheduling classes, Streams modules, and system calls. These modules are compiled and subsequently linked together to form the kernel. Subsequently, when the system is started or “booted,” the kernel is loaded into memory.

Each module in the kernel has its own unique configuration. Some modules may include tunables, which govern the behavior of the kernel. Some tunables enable optional kernel behavior, and allow a system administrator to adapt a kernel to the environment-specific requirements. In the discussion that follows, a module refers to any separately configurable unit of kernel code; a system file refers to a flat text file that contains administrator configuration choices in a compact, machine-readable and/or human readable format; and module metadata refers to data that describes a module's capabilities and characteristics.

A clustered computing arrangement may be configured to provide scalability, continuous availability, and to simplify administration of computing resources. A cluster will typically include a number of nodes that are interconnected via a suitable network with shared network storage between the nodes. Each node includes one or more processors, local memory resources, and various input/output components suitable for the hosted application(s). In large enterprises the nodes of the cluster may be geographically dispersed.

Each node in the cluster has a kernel configuration that must be suitably configured and managed in order for the node to be an operative component in the cluster. Depending on the number of nodes in the cluster and the geographic distribution of the nodes, managing the kernel configurations of the nodes may be administratively burdensome. For example, it may be desirable to configure a new value for a tunable and apply the new value to all nodes in the cluster. However, performing the administrative operation on each node may be time consuming and for more complicated changes to the kernel configuration may risk the introduction of inconsistencies across nodes in the cluster. Also, instantiating a new node in the cluster with the same kernel configuration as other nodes in the cluster requires knowledge of those files needing to be replicated.

A method and apparatus that addresses these and other related problems may therefore be desirable.

### BRIEF DESCRIPTION OF THE DRAWINGS

FIG. 1 is a block diagram that illustrates a clustered data processing arrangement in which multiple nodes operate from shared network storage in accordance with an embodiment of the invention;

FIG. 2 is a block diagram that illustrates the layers of software that implement operations for updating kernel configurations of nodes in a cluster in accordance with various embodiments of the invention;

FIG. 3 is a flowchart of a process for instantiating nodes in a cluster using a pseudo-/stand in accordance with an embodiment of the invention;

FIG. 4 is a flowchart of an example process for changing the kernel configuration of a down node in a cluster in accordance with an embodiment of the invention; and

FIG. 5 is a flowchart of an example process for changing the kernel configuration of the nodes in a cluster while operating from one of the nodes in the cluster.

### DETAILED DESCRIPTION

The various embodiments of the invention provide an arrangement and approach for managing kernel configuration information for the nodes in a cluster. Approaches are described for creating a common set of kernel configuration information that may be used by each of the nodes in the cluster, thereby facilitating the addition of new nodes to the cluster. An administrator may optionally apply an update to the kernel configuration information for all the nodes in the cluster with a single action at one of the nodes. The embodiments of the invention also provide approaches for updating from one node, the kernel configuration information of another node that is down, thereby avoiding an unnecessary reboot of the targeted node.

The embodiments of the invention are described with reference to a specific operating system kernel, namely, that of the HP-UX operating system (OS). Some of the terminology and items of information may be specific to the HP-UX OS. However, those skilled in the art will recognize that the specifics of the HP-UX OS may be adapted and the concepts used with other operating systems.

In the HP-UX OS, the kernel configuration information is maintained in a file system that is referred to as the “/stand.” A kernel configuration is a logical collection of all administrator choices and settings that govern the behavior and capabilities of the kernel. Physically, a kernel configuration is a directory that contains sub-directories and files needed to realize the specified behavior. There may be multiple sets of kernel configuration information, each referenced as a kernel configuration for brevity. The /stand file system is where all kernel configurations reside including the currently running configuration and the configuration to be used at next boot.

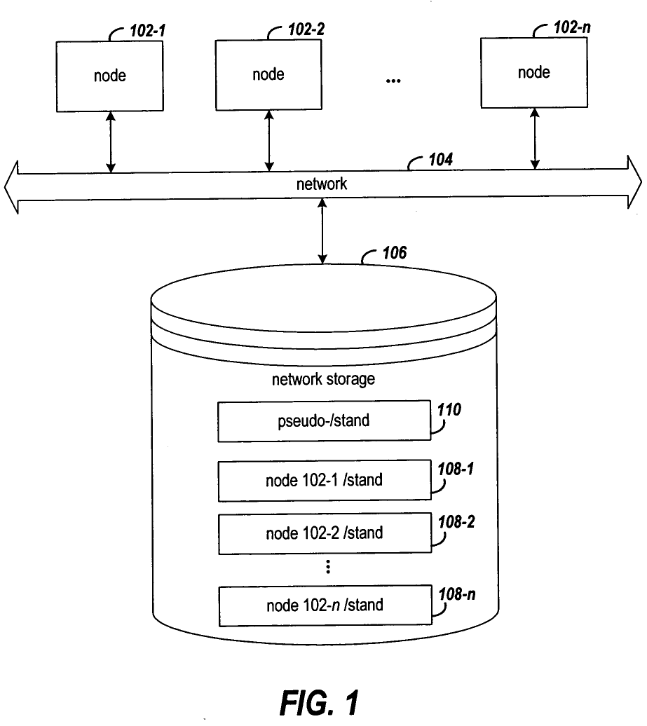

FIG. 1 is a block diagram that illustrates a clustered data processing arrangement in which multiple nodes operate from shared network storage in accordance with an embodiment of the invention. Arrangement 100 includes a plurality of nodes 102-1-102-n, a network 104, and a network storage arrangement 106. Each node is configured with an application-specific arrangement of one or more processors, local memory, I/O resources, and local storage. An instance of an OS executes and controls the resources of each node. Also, depending on application requirements, the network may be a local area network, a wide area network, or a combination thereof. The network storage is coupled to the network and provides persistent storage for information from each of the nodes in the cluster. Various known network attached storage arrangements and distributed file systems may be used to implement the network storage 106.

The kernel of each OS instance has its own /stand in network storage 106. For example, block 108-1 is the /stand for node 102-1, block 108-2 is the /stand for node 102-2, . . . , and block 108-n is the /stand for node 102-n. The pseudo-/stand 110 contains the kernel configuration information needed to create a /stand for a new node and boot an operating system on that node. The pseudo-/stand may be viewed as a “default”/stand from which other nodes may be instantiated. The pseudo-/stand 110 may be created by the system administrator using a tool for manipulating kernel configurations. The kernel-based tool provides the system administrator with the capability to not only create a pseudo-/stand from an existing /stand, but also with a single operation apply changes to all the kernel configurations in the cluster. In addition, an administrator may from one node change the /stand of another node that is down (“down” meaning the operating system is not booted).

The following paragraphs provide further description of the specific information in a /stand and in the pseudo-/stand. Each kernel configuration is stored in a directory in /stand. Saved configurations are stored in /stand/configname, where configname is the name of the saved configuration. The currently running configuration is stored in /stand/current. When the currently running configuration has changes being held for reboot, and those changes require different files in the configuration directory, the pending configuration is stored in /stand/nextboot. The rest of the time, /stand/nextboot is a symbolic link to the configuration marked for use the next time the node is booted (usually /stand/current). Table 1 describes the sub-directories and files under each configuration directory.

TABLE 1

| | |
|---|---|
| README | A README file reminding system administrators that they |
| | cannot safely modify any file in this directory except system |
| .config | A flag file, marking this as a directory containing a |
| | kernel configuration. Also used as a lock file for the |
| | configuration. |
| bootfs | The boot file system for this kernel configuration. |
| | (Only exists on IPF.) |
| mod | A directory containing the kernel modules in use in this kernel |
| | configuration |
| krs | A directory containing the kernel registry files for this |
| | kernel configuration |
| system | A text file describing this kernel configuration |
| vmunix | The kernel executable used with this kernel configuration |

The mod directory contains the module object files and preparation scripts for each kernel module used by the configuration (i.e., in a state other than unused). The module object files are named with the module name (no extension). The preparation scripts are optional scripts that will be invoked by the kernel configuration commands before and after loading and unloading a module.

The krs directory contains the file config.krs, which is the save file for the configuration-specific portion of the kernel registry database. It also contains config.krs.lkg, which is a last-known-good backup copy of that file, saved when the system was last successfully booted.

The bootfs directory contains a /stand/current directory, under which are symbolic links to the config file, krs files, and those module object files that correspond to modules capable of loading during kernel boot. The boot loader uses this directory to populate the RAM file system used during kernel boot.

Module object files, vmunix, and preparation scripts are often shared between configuration directories using hard links. However, there are not hard links to those files in the lastboot configuration directory.

When /stand/nextboot is a real directory, /stand/current/krs/config.krs is a symbolic link to /stand/nextboot/krs/config.krs.

Table 2 describes additional contents of a /stand.

TABLE 2

| | |
|---|---|
| boot.sys | The boot file system for configuration-independent files. |
| | (IPF only) |
| krs | A directory containing the system-global kernel registry files |
| system | A symbolic link to/stand/nextboot/system |
| vmunix | A symbolic link to/stand/current/vmunix |

The krs directory contains the file system.krs, which is the save file for the system-global portion of the kernel registry database. It also contains system.krs.lkg, which is the last-known-good backup copy of that file, saved when the system was last successfully booted.

The boot.sys directory contains a stand subdirectory with symbolic links to the ioconfig and system-global kernel registry files. The IPF boot loader uses this directory to populate the RAM file system used during kernel boot. It will be appreciated that /stand and /stand/boot.sys may contain other files that are unrelated to kernel configuration.

The pseudo-/stand directory resides under /var/adm/stand and is a shared directory in a cluster environment. When initially created, the pseudo-/stand directory contains the files and directories described in Table 3. With further cluster-wide kernel configuration operations performed by the system administrator, the pseudo-/stand may or may not contain saved kernel configurations.

TABLE 3

| | |
|---|---|
| current | A directory containing the current kernel configuration. |
| | It is a copy of the current kernel configuration of the first |
| | member joining the cluster. |
| nextboot | The nextboot kernel configuration. It is an exact replica |
| | of the nextboot kernel configuration of the first member |
| | joining the cluster. |
| system | A symbolic link to/var/adm/nextboot/system |
| vmunix | A symbolic link to/var/adm/current/vmunix |

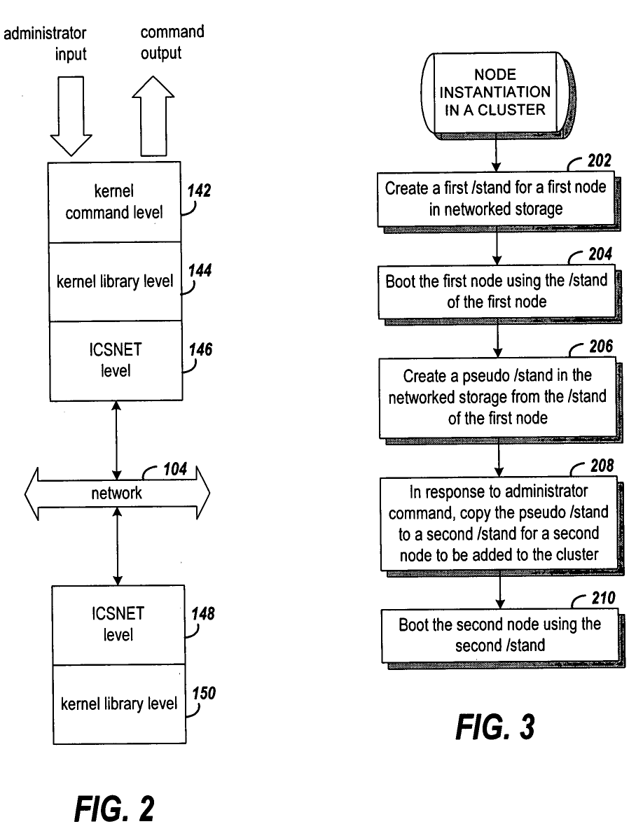

FIG. 2 is a block diagram that illustrates the layers of software that implement operations for updating kernel configurations of nodes in a cluster in accordance with various embodiments of the invention. In an example embodiment, a command driven interface is provided to an administrator to manage kernel configurations. Those skilled in the art will recognize that various graphical user interface (GUI) techniques may be employed in the alternative or in combination. As user interface technology advances a voice activated interface may be used.

The kernel configuration command level 142 parses the command line input by the administrator and validates the operation being requested. The command level invokes functions in the kernel configuration library level 144 to perform the operations requested. The functions in the library level perform the actual work for the requested operation. The kernel command level code is adapted to accept options to specify member-specific and cluster-wide operations in kernel configurations. Thus, with a single command an administrator may change the kernel configurations of all the nodes in the cluster.

Example kernel configuration operations include managing whole kernel configurations, changing tunable parameter settings, and changing device bindings. Separate commands with separate options may be constructed for each operation according to implementation requirements. Operations on whole kernel configurations may include making a copy of the source, deleting a saved kernel configuration, erasing all changes to a currently running configuration being held for the next boot, loading a named kernel configuration into the currently running node, creating a pseudo-/stand, marking a saved kernel configuration for use at the next reboot, updating the /stand of a new node to the cluster with the pseudo-/stand, save the running kernel configuration under a new name. Selected ones of the operations on whole kernel configurations may be selectively applied to all nodes in the cluster or selectively applied to only those nodes specified on the command line.

The inter-node communications subsystem network driver ICSNET level 146 provides a reliable and secure mechanism to address and communicate between nodes in a cluster and is used to remotely invoke commands on the target node(s). The ICSNET level provides an interconnect-independent virtual network interface to the cluster interconnect fabric. ICSNET is implemented as a network device driver. It provides an Ethernet-like service interface to the functions in the kernel library level 144. Other subsystems are used to transfer data packets between nodes in the cluster and track cluster membership. Generic TCP/IP and UDP/IP applications may use ICSNET to communicate with other cluster members over the cluster interconnect. Such applications typically access ICSNET by specifying the hostname-ics0 name, for example ‘telnet host2-ics0’.

On the node(s) targeted by a kernel configuration command, the ICSNET level 148 interfaces with the ICSNET level 146 on the node from which the command was initiated. The ICSNET level on the target node invokes the appropriate function in the kernel library 150, and the function performs the kernel configuration update on the /stand for the target node, which is the node that hosts the library level 150. Status information resulting from performing the operation on the target node is returned to the administrator via the ICSNET levels 148 and 146, and kernel library level 144 and kernel command level 142. The inability of the ICSNET level on a node from which a command is initiated to communicate with the ICSNET level on a target node may indicate to the initiating node that the target node is down.

FIG. 3 is a flowchart of a process for instantiating nodes in a cluster using a pseudo-/stand in accordance with an embodiment of the invention. In instantiating the first node in the cluster, a /stand is created for the first node in networked storage at step 202. The installation of the first node may be accomplished with the same procedure as is used for installation of a non-clustered system.

Once the /stand is created for the first node, that node may be booted as shown by step 204. Once the first node is established in the cluster, additional nodes may be added using the /stand of the first node to create a pseudo-/stand and then using the pseudo-/stand to create /stands for the new nodes. A new node added to the cluster will use a copy of directories and files in the pseudo-/stand directory. The /stand for the next node to be added will be created from the pseudo-/stand before the new node is booted. When the new node boots into the cluster with its /stand, it will boot with a kernel configuration identical to that of the first node in the cluster. In an example embodiment, kernel configuration commands may be provided for creating the pseudo-/stand and for copying the pseudo-/stand to the /stand for a new node.

At step 206, the administrator creates a pseudo-/stand from the /stand of the first node in the system using a command that creates the pseudo-/stand. The pseudo-/stand will have the information described above that is copied from the /stand of the first node. At step 208, the administrator uses another command to copy the pseudo-/stand to the /stand for a second node added to be added to the cluster. The /stand for the new node contains the information described above and resides on the networked storage so that the new node may access the /stand and the /stand may be updated from another node in the cluster.

Once the /stand is in place, the new node may be booted with the /stand as shown by step 210. A disk configuration utility operating on the second node may be used to set this /stand as the boot disk.

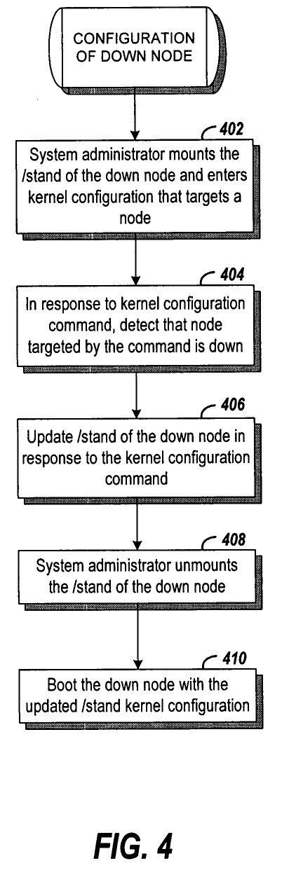

FIG. 4 is a flowchart of an example process for changing the kernel configuration of a down node in a cluster in accordance with an embodiment of the invention. The networked storage of the /stands for the nodes in the cluster allows an administrator to operate from one node and change the kernel configuration of a target node that is down. The administrator may thereby avoid an extra reboot of the target node in order to have the kernel configuration changes take effect. In addition, the administrator may operate on the kernel configuration of the target node without having to perform extra operations when the node is down.

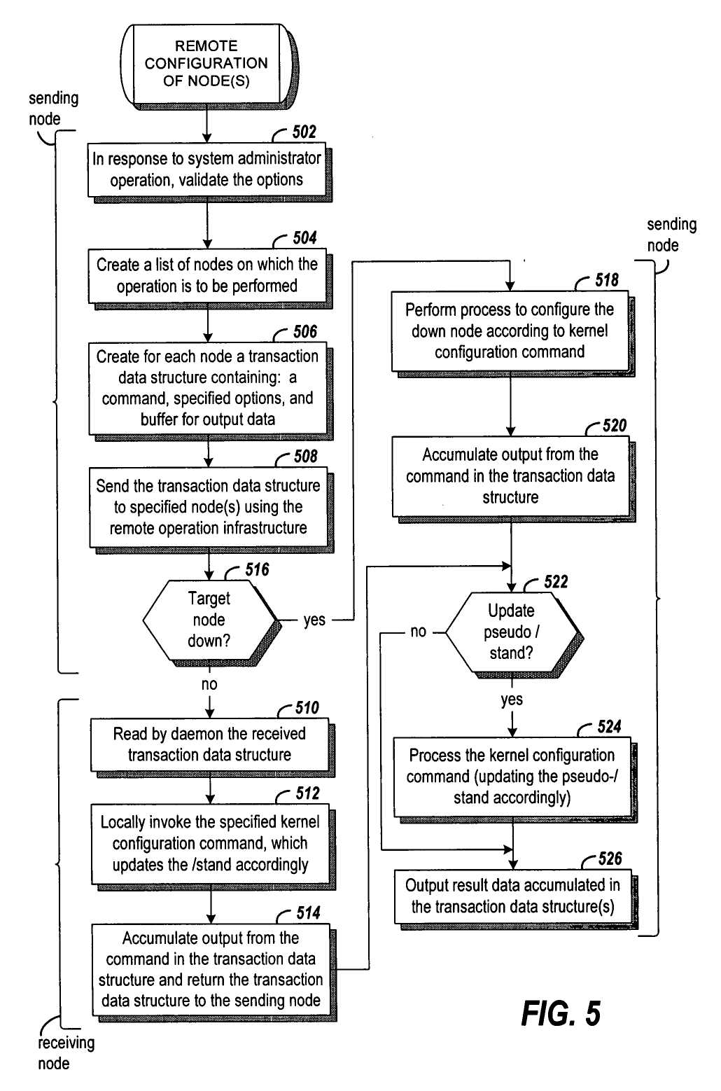

Since each kernel configuration is maintained as a file system, the administrator first mounts the /stand of the down node as shown by step 402. The administrator may then enter a kernel configuration command that targets a desired node, which the administrator may or may not know to be down. The different types of commands may be for changing module configuration settings, changing tunable parameter settings, and changing device bindings. At step 404, the kernel configuration software detects that the targeted node is down in response to attempting to contact the target node. Note that for a targeted node that is up and running, the kernel configuration software operating on the node from which the command was entered transmits the command to kernel configuration software that is operating on the target node, and the kernel configuration software on the target node processes the command accordingly. This scenario is shown in FIG. 5.

In response to the target node being down, the kernel configuration software on the node on which the command was entered references the /stand of the down node in network storage 106 and updates the /stand according to the command and any parameters provided with the command as shown by step 406. Once the operation is complete, the administrator unmounts the /stand of the down node at step 408. Once the /stand of the down node has been suitably updated, the administrator may boot the target node as shown by step 410.

FIG. 5 is a flowchart of an example process for changing the kernel configuration of the nodes in a cluster while operating from one of the nodes in the cluster. The blocks in the flowchart are grouped according to processing performed at the node from which the administrator initiates the command (“sending node”) and one of the nodes in the cluster at which the kernel configuration command is executed (“receiving node”). The processing associated with the receiving node is the same for each of the nodes (that is not down) in the cluster.

In response to input of a kernel configuration command, at step 502 the process validates the options on the command. If any command option is found to be invalid processing of the command may be aborted. At step 504, the process creates a list of nodes on which operation is to be performed. The administrator may input an option that specifies that all nodes in the cluster are targets, or may alternatively input an option that identifies certain ones of the nodes in the cluster. It will be appreciated that an administrator may use other cluster management commands to track the various information, including identifiers, pertaining to the nodes in the cluster.

A transaction data structure is created for each target node at step 506 to store the information needed by each of the nodes to process the command. The information includes a specification of the command, for example, a text string or command code and specification of options associated with the command. The data structure may also include a buffer for output data to be returned from the target node.

At step 508, the transaction data structure is sent to each of the specified nodes using the ICSNET level software. If a targeted node is down, decision step 516 directs the process to step 518, where the sending node performs the process for configuring a down node as described in FIG. 4. Since the sending node is performing the kernel configuration for the down node, the sending node updates the transaction data structure for the down node with information returned from the kernel update procedure as shown by step 520.

If the target node is not down, the process is directed from decision step 516 to step 510 where a daemon executing on the receiving node reads from the received transaction data structure. The daemon then invokes the kernel configuration command on the receiving node at step 512, which results in update of the /stand of the receiving node according to the command and parameters. At step 514, the receiving node accumulates output from the command in the transaction data structure and returns the transaction data structure to the sending node.

Once the sending node has received all the transaction data structures from the targeted nodes (step 514) and processed any down nodes (step 520), at step 522 the sending node checks whether the pseudo-/stand is to be updated. The pseudo-/stand will only be updated for commands that target all nodes in the cluster. For example, a command option may allow the administrator to enter a specific node identifier to target one node or enter “all” to target all nodes in the cluster (if no option is specified the default may be to apply the update only to the node on which the command was entered) If the pseudo-/stand is to be updated, the configuration command is processed against the pseudo-/stand at step 524. Once processing is complete the output data in the transaction data structure(s) from the receiving node(s) and data accumulated for processing of any down node(s) is output for review by the administrator at step 526.

Those skilled in the art will appreciate that various alternative computing arrangements would be suitable for hosting the processes of the different embodiments of the present invention. In addition, the processes may be provided via a variety of computer-readable media or delivery channels such as magnetic or optical disks or tapes, electronic storage devices, or as application services over a network.

The present invention is believed to be applicable to a variety of clustered computing arrangement and supporting operating systems. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A processor-implemented method for managing kernel configuration files in a cluster computing arrangement, comprising:
installing a first set of kernel configuration files in networked storage;
booting a first node of the cluster using the first set of kernel configuration files;
storing a copy of the first set of kernel configuration files in networked storage as a default kernel configuration in response to an administrator initiated first operation, wherein the first operation copies all kernel configuration files needed for booting any node in the cluster;
storing a copy of the default kernel configuration as a second set of kernel configuration files for a second node of the cluster in response to an administrator-initiated second operation wherein the second operation copies all kernel configuration files needed for booting the second node; and
booting the second node with the second set of kernel configuration files.

2. The method of claim 1, further comprising:
storing respective copies of the default kernel configuration as respective sets of kernel configuration files for a plurality of nodes of the cluster in response to one or more administrator-initiated operations; and
in response to an administrator-initiated third operation from one of the nodes in the cluster that specifies a change to all sets of kernel configuration files for all the nodes in the cluster, executing respective update operations on the nodes in the cluster, wherein each respective update operation changes the respective set of kernel configuration files as specified by the third operation, and changes the first and second sets of kernel configuration files.

3. The method of claim 2, wherein the default kernel configuration is stored in a default set of kernel configuration files, the method further comprising, in response to the administrator-initiated third operation, changing the default set of kernel configuration files as specified by the third operation.

4. The method of claim 1, further comprising in response to an administrator-initiated third operation from the first node that specifies a change to the second set of kernel configuration files for the second node and the second node being in a down state, executing software on the first node that performs the third operation and changing the second set of kernel configuration files as specified by the third operation.

5. The method of claim 4, further comprising in response to the administrator-initiated third operation from the first node that specifies a change to the second set of kernel configuration files for the second node and the second node being in an up state, executing software on the second node that performs the third operation and changing the second set of kernel configuration files as specified by the third operation.

6. The method of claim 1, further comprising:
storing respective copies of the default kernel configuration as respective sets of kernel configuration files for a plurality of nodes of the cluster in response to respective administrator-initiated operations for the plurality of nodes;
in response to an administrator-initiated single third operation from one of the nodes in the cluster that specifies a change to all sets of kernel configuration files for all the nodes in the cluster, determining by software executing on the one of the nodes for each node whether the node is in an up state or a down state;
in response to each node determined to be in an up state, executing software on the node that updates the respective set of kernel configuration files of the node in the up state as specified by the third operation; and
in response to each node determined to be in a down state, executing the third operation on the first node and changing the respective set of kernel configuration files of the node in the down state as specified by the third operation.

7. The method of claim 6, further comprising:
executing a daemon on each of the nodes for receiving remotely initiated kernel configuration operations;
transmitting a respective transaction data structure from the one of the nodes to the daemon on each of the nodes in an up state in response to the third operation, wherein the transaction data structure includes a specification of the operation and buffer space;
receiving the respective transaction data structure by each of the daemons, and invoking by each daemon software on the node for performing the third operation; and
at each node in the up state, storing in the buffer space in the transaction data structure data provided in response performing the third operation, and returning the transaction data structure to the one of the nodes.

8. The method of claim 6, wherein the default kernel configuration is stored in a default set of kernel configuration files, the method further comprising, in response to the administrator-initiated third operation, changing the default set of kernel configuration files as specified by the third operation.

9. The method of claim 1, further comprising storing each set of kernel configuration files as a respective mountable file system.

10. A program storage medium, comprising:
a processor-readable device configured with instructions that when executed manage kernel configuration files in a cluster computing arrangement by performing the steps including,
installing a first set of kernel configuration files in networked storage;
booting a first node of the cluster using the first set of kernel configuration files;
storing a copy of the first set of kernel configuration files in networked storage as a default kernel configuration in response to an administrator initiated first operation, wherein the first operation copies all kernel configuration files needed for booting any node in the cluster;
storing a copy of the default kernel configuration as a second set of kernel configuration files for a second node of the cluster in response to an administrator-initiated second operation wherein the second operation copies all kernel configuration files needed for booting the second node; and
booting the second node with the second set of kernel configuration files.

11. The storage medium of claim 10, the steps further comprising:
storing respective copies of the default kernel configuration as respective sets of kernel configuration files for a plurality of nodes of the cluster in response to one or more administrator-initiated operations; and
in response to an administrator-initiated third operation from one of the nodes in the cluster that specifies a change to all sets of kernel configuration files for all the nodes in the cluster, executing respective update operations on the nodes in the cluster, wherein each respective update operation changes the respective set of kernel configuration files as specified by the third operation, and changes the first and second sets of kernel configuration files.

12. The storage medium of claim 11, wherein the default kernel configuration is stored in a default set of kernel configuration files, the steps further comprising, in response to the administrator-initiated third operation, changing the default set of kernel configuration files as specified by the third operation.

13. The storage medium of claim 10, the steps further comprising in response to an administrator-initiated third operation from the first node that specifies a change to the second set of kernel configuration files for the second node and the second node being in a down state, executing software on the first node that performs the third operation and changing the second set of kernel configuration files as specified by the third operation.

14. The storage medium of claim 13, the steps further comprising in response to the administrator-initiated third operation from the first node that specifies a change to the second set of kernel configuration files for the second node and the second node being in an up state, executing software on the second node that performs the third operation and changing the second set of kernel configuration files as specified by the third operation.

15. The storage medium of claim 10, the steps further comprising:
storing respective copies of the default kernel configuration as respective sets of kernel configuration files for a plurality of nodes of the cluster in response to respective administrator-initiated operations for the plurality of nodes;
in response to an administrator-initiated single third operation from one of the nodes in the cluster that specifies a change to all sets of kernel configuration files for all the nodes in the cluster, determining by software executing on the one of the nodes for each node whether the node is in an up state or a down state;
in response to each node determined to be in an up state, executing software on the node that updates the respective set of kernel configuration files of the node in the up state as specified by the third operation; and
in response to each node determined to be in a down state, executing the third operation on the first node and changing the respective set of kernel configuration files of the node in the down state as specified by the third operation.

16. The storage medium of claim 15, the steps further comprising:
executing a daemon on each of the nodes for receiving remotely initiated kernel configuration operations;
transmitting a respective transaction data structure from the one of the nodes to the daemon on each of the nodes in an up state in response to the third operation, wherein the transaction data structure includes a specification of the operation and buffer space;
receiving the respective transaction data structure by each of the daemons, and invoking by each daemon software on the node for performing the third operation; and
at each node in the up state, storing in the buffer space in the transaction data structure data provided in response performing the third operation, and returning the transaction data structure to the one of the nodes.

17. The storage medium of claim 15, wherein the default kernel configuration is stored in a default set of kernel configuration files, the steps further comprising, in response to the administrator-initiated third operation, changing the default set of kernel configuration files as specified by the third operation.

18. The storage medium of claim 10, the steps further comprising storing each set of kernel configuration files as a respective mountable file system.

19. A system for managing kernel configuration files in a cluster computing arrangement, comprising:
means for installing a first set of kernel configuration files in networked storage;
means for booting a first node of the cluster using the first set of kernel configuration files;
means for storing a copy of the first set of kernel configuration files in networked storage as a default kernel configuration in response to an administrator initiated first operation, wherein the first operation copies all kernel configuration files needed for booting any node in the cluster;
means for storing a copy of the default kernel configuration as a second set of kernel configuration files for a second node of the cluster in response to an administrator-initiated second operation wherein the second operation copies all kernel configuration files needed for booting the second node; and
means for booting the second node with the second set of kernel configuration files.

20. The system of claim 19, further comprising:
means for storing respective copies of the default kernel configuration as respective sets of kernel configuration files for a plurality of nodes of the cluster in response to one or more administrator-initiated operations;
means, responsive to an administrator-initiated third operation from one of the nodes in the cluster that specifies a change to all sets of kernel configuration files for all the nodes in the cluster, for executing respective update operations on the nodes in the cluster, wherein each respective update operation changes the respective set of kernel configuration files as specified by the third operation, and changes the first and second sets of kernel configuration files;
wherein the default kernel configuration is stored in a default set of kernel configuration files; and
means, responsive to the administrator-initiated third operation, for changing the default set of kernel configuration files as specified by the third operation.

21. The system of claim 19, further comprising:
means for storing respective copies of the default kernel configuration as respective sets of kernel configuration files for a plurality of nodes of the cluster in response to respective administrator-initiated operations for the plurality of nodes;
means, responsive to an administrator-initiated single third operation from one of the nodes in the cluster that specifies a change to all sets of kernel configuration files for all the nodes in the cluster, for determining by software executing on the one of the nodes for each node whether the node is in an up state or a down state;
means, responsive to each node determined to be in an up state, for executing software on the node that updates the respective set of kernel configuration files of the node in the up state as specified by the third operation; and
means, responsive to each node determined to be in a down state, for executing the third operation on the first node and changing the respective set of kernel configuration files of the node in the down state as specified by the third operation.
